(19) United States
(12) Patent Application Publication
(10) Pub. No.: US 2021/0239487 A1
(43) Pub. Date: Aug. 5, 2021

(54) INFORMATION PROVIDING DEVICE, VEHICLE, AND METHOD OF PROVIDING INFORMATION

(71) Applicant: HONDA MOTOR CO., LTD., Tokyo (JP)

(72) Inventors: Masahide KOBAYASHI, WAKO-SHI (JP); Shintaro MASU, WAKO-SHI (JP)

(21) Appl. No.: 17/160,826

(22) Filed: Jan. 28, 2021

(30) Foreign Application Priority Data
Jan. 30, 2020 (JP) 2020-013132

(51) Int. Cl. G01C 21/36; G08G 1/0962; G01C 21/34; G01S 19/42

(52) U.S. Cl. CPC G01C 21/3626; G08G 1/09626; G01S 19/42; G01C 21/3691; G01C 21/3484

(57) ABSTRACT

An information providing device is equipped with a position information acquisition unit that acquires information concerning a position of a user's own vehicle, a regional information acquisition unit that acquires regional information defined by information concerning a region located on a travel route of the user's own vehicle, and a providing unit that provides the regional information acquired by the regional information acquisition unit in accordance with the position of the user's own vehicle, in the case it is determined by a determination unit that a visiting experience of a driver is less than an experience threshold value, or in the case it is determined by the determination unit that a visiting interval of the driver is greater than or equal to an interval threshold value.

### CROSS-REFERENCE TO RELATED APPLICATION

This application is based upon and claims the benefit of priority from Japanese Patent Application No. 2020-013132 filed on Jan. 30, 2020, the contents of which are incorporated herein by reference.

### BACKGROUND OF THE INVENTION

### Field of the Invention

The present invention relates to an information providing device, a vehicle, and a method of providing information.

### Description of the Related Art

In Japanese Laid-Open Patent Publication No. 2006-184008, an information providing device is disclosed which is equipped with a store information acquisition means for acquiring store information indicative of information of stores existing in a vicinity of a user's own vehicle, a vehicle occupant information acquisition means for acquiring vehicle occupant information, and a store selection means for selecting stores to be presented to the vehicle occupant based on the vehicle occupant information and the store information.

### SUMMARY OF THE INVENTION

However, in the device according to Japanese Laid-Open Patent Publication No. 2006-184008, in a territory or region with which the driver is unfamiliar, information of such a relevant region cannot be provided in accordance with the driving experience of the driver.

An object of the present invention has the object of providing an information providing device, a vehicle, and a method of providing information, which are capable of providing information of relevant regions in accordance with a driving experience.

An information providing device according to one aspect of the present invention includes a position information acquisition unit configured to acquire information concerning a position of a user's own vehicle, a determination unit configured to determine whether or not a visiting experience of a driver with respect to a region located on a travel route of the user's own vehicle is less than an experience threshold value, or alternatively, whether or not a visiting interval of the driver with respect to the region located on the travel route of the user's own vehicle is greater than or equal to an interval threshold value, a regional information acquisition unit configured to acquire regional information defined by information concerning the region located on the travel route of the user's own vehicle, and a providing unit configured to provide the regional information acquired by the regional information acquisition unit in accordance with the position of the user's own vehicle, in the case it is determined by the determination unit that the visiting experience of the driver is less than the experience threshold value, or in the case it is determined by the determination unit that the visiting interval of the driver is greater than or equal to the interval threshold value.

A vehicle according to another aspect of the present invention includes the above-described information providing device.

A method of providing information according to still another aspect of the present invention includes a step of acquiring information concerning a position of a user's own vehicle, a determination step of determining whether or not a visiting experience of a driver with respect to a region located on a travel route of the user's own vehicle is less than an experience threshold value, or alternatively, whether or not a visiting interval of the driver with respect to the region located on the travel route of the user's own vehicle is greater than or equal to an interval threshold value, a regional information acquisition step of acquiring regional information defined by information concerning the region located on the travel route of the user's own vehicle, and a step of providing the regional information acquired by the regional information acquisition step in accordance with the position of the user's own vehicle, in the case it is determined in the determination step that the visiting experience of the driver is less than the experience threshold value, or in the case it is determined in the determination step that the visiting interval of the driver is greater than or equal to the interval threshold value.

According to the present invention, the information providing device, the vehicle, and the method of providing information can be provided, which are capable of providing information of relevant regions in accordance with the driving experience.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a diagram showing a vehicle equipped with an information providing device according to an embodiment of the present invention;

FIG. 2 is a block diagram showing the information providing device according to the embodiment;

FIG. 3 is a diagram showing an example of a visiting history database;

FIG. 4 is a diagram showing an example of a regional information database; and

FIG. 5 is a flowchart showing operations of the information providing device according to the embodiment.

### DETAILED DESCRIPTION OF THE PREFERRED EMBODIMENTS

Preferred embodiments of an information providing device, a vehicle, and a method of providing information according to the present invention will be presented and described in detail below with reference to the accompanying drawings.

### Embodiment

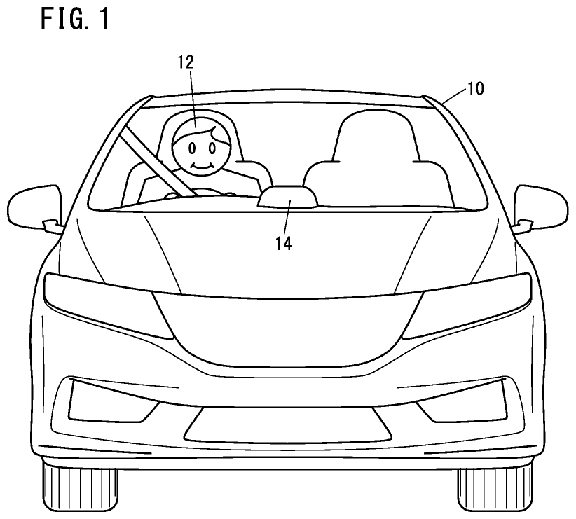

An information providing device, a vehicle, and an information providing method according to one embodiment will be described with reference to FIGS. 1 to 5. FIG. 1 is a block diagram showing a vehicle equipped with the vehicle providing device according to the present embodiment.

Vehicle occupants including a driver 12 are capable of boarding a vehicle (user's own vehicle, driver's own vehicle) 10. In the example shown in FIG. 1, the driver 12 is seated in a driver's seat which is provided in the vehicle 10.

The vehicle 10 is equipped with an information providing device 14. In this instance, an exemplary case will be described in which the information providing device 14 also serves as a navigation device, however, the present invention is not limited to this feature. The information providing device 14 and the navigation device may also be provided separately.

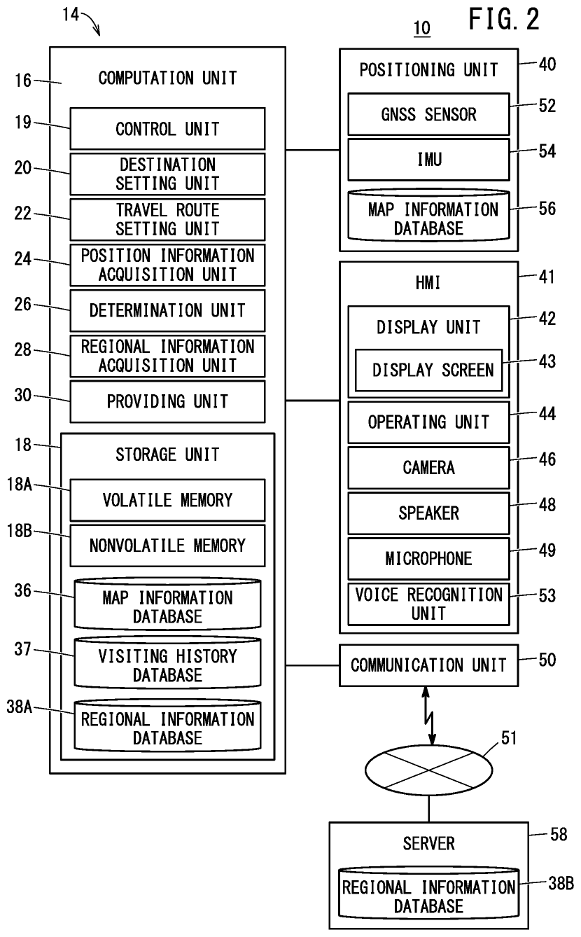

FIG. 2 is a block diagram showing the information providing device 14 according to the present embodiment.

As shown in FIG. 2, the information providing device 14 is equipped with a computation unit 16 and a storage unit 18. The computation unit 16 can be constituted by at least one processor. As an example of such a processor, there may be cited a CPU (Central Processing Unit) or the like.

The storage unit 18 includes a volatile memory 18A and a nonvolatile memory 18B. As an example of the volatile memory 18A, there may be cited a RAM (Random Access Memory) or the like. As an example of the nonvolatile memory 18B, there may be cited a ROM (Read Only Memory), a flash memory, or the like. Programs, tables, maps, and the like are stored, for example, in the nonvolatile memory 18B. The storage unit 18 may further include an HDD (Hard Disk Drive).

In the storage unit 18, there may be included a map information database 36, a regional information database 38A, and a visiting history database 37. In this instance, a case will be described in which the regional information database 38A is provided in the storage unit 18, whereas another regional information database 38B is provided in a server 58, however, the present invention is not limited to this feature. For example, the regional information database 38A may be provided in the storage unit 18, while on the other hand, the regional information database 38B need not be provided in the server 58. Further, the regional information database 38B may be provided in the server 58, while on the other hand, the regional information database 38A need not be provided in the storage unit 18. Reference numeral 38 will be used when the regional information databases are described in general, and the reference numerals 38A and 38B will be used when describing the individual regional information databases. Further, in this instance, an exemplary case will be described in which the visiting history database 37 is provided in the storage unit 18, however, the present invention is not limited to this feature. For example, the visiting history database 37 may be provided in the server 58.

A positioning unit 40, an HMI (human machine interface) 41, and a communication unit 50 can be connected to the information providing device 14.

The positioning unit 40 is equipped with a GNSS (Global Navigation Satellite System) sensor 52. The positioning unit 40 is further provided with an IMU (Inertial Measurement Unit) 54 and a map information database 56. The positioning unit 40 is capable of specifying the position of the vehicle 10 by appropriately using the information obtained by the GNSS sensor 52, the information obtained by the IMU 54, and the map information stored in the map information database 56. The positioning unit 40 can supply information indicating the position, i.e., the current position, of the vehicle 10 to the information providing device 14.

The HMI 41 is capable of accepting operations input by the user, as well as providing various information to the user. The HMI 41 is equipped, for example, with a display unit 42, an operating unit 44, a camera 46, a speaker 48, and a microphone 49.

The display unit 42 can visually provide various information to the user. As the display unit 42, there can be used, for example, a liquid crystal display, an organic EL display, or the like, however, the display unit 42 is not limited to such displays. The information providing device 14 is capable of displaying the regional information and the like on the display screen 43 of the display unit 42.

The operating unit (operation input unit) 44 is capable of accepting operations input by the user. In the case that the display unit 42 is equipped with a touch panel, the touch panel can function as the operating unit 44. The operating unit 44 may supply information to the information providing device 14 in accordance with operations input by the user.

The camera 46 is capable of capturing images of the interior of the vehicle 10, or stated otherwise, the vehicle interior. The camera 46 can capture images of the driver 12 and the like. The camera 46 may be provided, for example, on a dashboard which is provided in the vehicle 10, or may be provided on a ceiling of the vehicle 10. The information acquired by the camera 46, namely, image information, can be supplied to the information providing device 14.

The speaker (voice output device) 48 can provide various information to the user in an audible manner. The information providing device 14 may provide the regional information to the driver 12 by voice via the speaker 48.

The microphone (voice input device) 49 is capable of acquiring sounds in the interior of the vehicle 10, or stated otherwise, vehicle interior sounds. The microphone 49 may acquire a voice emitted from the driver 12. The HMI 41 is equipped with a voice recognition unit 53. The voice recognition unit 53 performs a voice recognition process on the sounds acquired by the microphone 49. The voice recognition unit 53 can supply the results of the voice recognition process to the information providing device 14. In this manner, information corresponding to the voice of the driver 12 and the like can be supplied to the information providing device 14.

The communication unit 50 is capable of carrying out wireless communications with external equipment. The external equipment may include, for example, a server (external server) 58 or the like. The server 58 may be equipped, for example, with the regional information database 38B. Communications between the communication unit 50 and the server 58 may be performed via a network 51 such as the Internet.

In the computation unit 16, there are provided a control unit 19, a destination setting unit 20, a travel route setting unit 22, a position information acquisition unit 24, a determination unit 26, a regional information acquisition unit 28, and a providing unit 30. The control unit 19, the destination setting unit 20, the travel route setting unit 22, the position information acquisition unit 24, the determination unit 26, the regional information acquisition unit 28, and the providing unit 30 can be realized by programs, which are stored in the storage unit 18, being executed by the computation unit 16.

The control unit 19 governs the overall control of the information providing device 14.

The destination setting unit 20 sets a destination based on an operation performed by the user via the operating unit 44 or the like.

The travel route setting unit 22 reads out map information corresponding to the current position from the map information database 36 that is stored in the storage unit 18. Information of the current position, and more specifically, information indicating the position of the vehicle 10, can be supplied from the positioning unit 40, as has been described above. Using the map information, the travel route setting unit 22 can determine a target route from the current position to the destination, or stated otherwise, a travel route of the vehicle 10.

The position information acquisition unit 24 is capable of acquiring information concerning the position of the user's own vehicle 10. The position information acquisition unit 24 can acquire the information concerning the position of the user's own vehicle 10 based on the information supplied from the positioning unit 40.

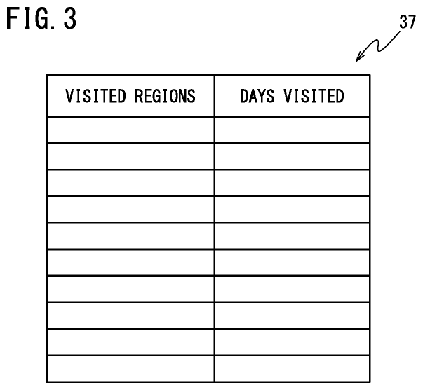

As shown in FIG. 3, the visiting history database 37 may store information indicating visited regions, i.e., regions which have been visited by the driver 12. FIG. 3 is a diagram showing an example of the visiting history database 37. Further, the visiting history database 37 may store information indicating visited dates, and in particular, visited dates indicating dates in which the driver 12 has visited the relevant regions. The visited regions and the visited dates are associated with each other and stored in the visiting history database 37.

The determination unit 26 can determine a visiting experience of the driver 12 with respect to a region located on the travel path of the user's own vehicle 10. The visiting experience, for example, is a number of times that the driver 12 has visited the relevant region. The determination unit 26 can determine the number of times that the driver 12 has visited the relevant region on the basis of the information that is stored in the visiting history database 37. Moreover, in this instance, although an exemplary case is described in which the visiting experience of the driver 12 with respect to the relevant region is determined based on the information stored in the visiting history database 37, the present invention is not necessarily limited to this feature. An inquiry may be made to the driver 12 via the HMI 41 concerning the visiting experience of the driver 12 with respect to the relevant region, and the visiting experience of the driver 12 with respect to the relevant region may be determined by the determination unit 26 based on the response from the driver 12.

The determination unit 26 can determine whether or not the visiting experience of the driver 12 with respect to the relevant region is less than an experience threshold value (i.e., whether or not the visiting experience < the experience threshold value). The experience threshold value, for example, can be one time, however, the present invention is not limited to this feature. In the case that the experience threshold value is set, for example, to one time, and if the driver 12 has made a visit with respect to the relevant region even once, then the visiting experience of the driver 12 with respect to the relevant region is not considered to be less than the experience threshold value. Moreover, the experience threshold value may be set automatically by the control unit 19, or may be set based on a request from the user.

The determination unit 26 can determine whether or not a visiting interval of the driver 12 with respect to the relevant region is greater than or equal to an interval threshold value (i.e., whether or not the visiting interval ≥ the interval threshold value). The visiting interval threshold value, for example, can be one year, however, the present invention is not limited to this feature. The visiting interval threshold value may be set automatically by the control unit 19, or may be set based on a request from the user.

The determination unit 26 can determine the visiting interval of the driver 12 with respect to the region located on the travel path of the user's own vehicle 10. The visiting interval is a period from the time at which the driver 12 last visited the relevant region to the present. The determination unit 26 can determine the visiting interval of the driver 12 with respect to the relevant region on the basis of the information that is stored in the visiting history database 37. Moreover, in this instance, although an exemplary case is described in which the visiting interval of the driver 12 with respect to the relevant region is determined based on the information stored in the visiting history database 37, the present invention is not necessarily limited to this feature. An inquiry may be made to the driver 12 via the HMI 41 concerning the visiting interval of the driver 12 with respect to the relevant region. Then, the visiting interval of the driver 12 with respect to the relevant region may be determined by the determination unit 26 based on the response from the driver 12.

In the case that the travel route has been determined by the travel route setting unit 22, the determination unit 26 may collectively determine the visiting experiences and the like with respect to all of the regions on the travel route from the current position to the destination. However, the present invention is not necessarily limited to this feature. For example, among all of the regions on the travel route from the current position to the destination, the visiting experience and the like with respect to a region or regions for which the distance thereof from the current position is less than or equal to a predetermined distance may be determined. In this case, the visiting experiences and the like are sequentially determined according to changes in the current position of the user's own vehicle 10.

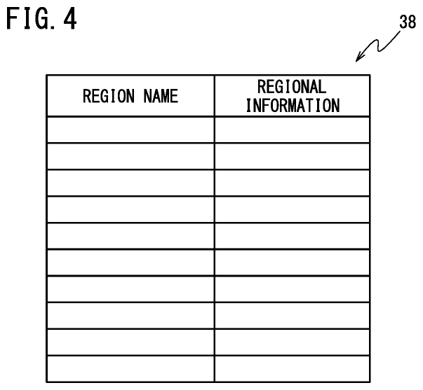

The regional information acquisition unit 28 can acquire regional information, which is information concerning a region that is located on the travel route of the user's own vehicle 10. The regional information acquisition unit 28 can acquire the regional information from the regional information database 38. FIG. 4 is a diagram showing an example of the regional information database 38. In the regional information database 38, information indicating the names of regions, or stated otherwise, regional names may be stored. Further, the regional information database 38 is capable of storing regional information which is information concerning the relevant regions. The names of the regions and the regional information are associated with each other and stored in the regional information database 38. Moreover, in this instance, an exemplary case will be described in which the regional information is acquired from the regional information database 38, however, the present invention is not limited to this feature. For example, the regional information may be acquired from a social networking service or the like.

In the regional information, there can be included, for example, information concerning customs of the relevant regions. As the information concerning customs of the relevant regions, there may be cited, for example, a custom such as not shaking hands with the left hand, although the present invention is not limited to this feature.

In the regional information, there can be included information concerning traffic customs of the relevant regions. As the information concerning traffic customs of the relevant regions, there may be cited, for example, a custom such as a tendency to shorten the inter-vehicular distance between vehicles, although the present invention is not limited to this feature. For example, in the United States, the United Kingdom, and the like, the traffic custom noted below can be cited as a traffic custom related to driving in ring-shaped intersections (roundabouts). More specifically, vehicles which have entered initially into the roundabout are able to travel preferentially. In addition, in the United States and other countries, the following traffic custom can be cited as a traffic custom in relation to turning right at a red light. More specifically, at a red light, automobiles may be permitted to turn to the right if safety in the frontward left and right directions can be confirmed. However, if there is a sign indicating NO RIGHT TURN ON RED, automobiles are prohibited from making a right turn at the red light. Further, in the United States and other countries, the following traffic custom can be cited as a traffic custom in relation to temporarily stopping at a railroad crossing. More specifically, it is not obligatory to temporarily stop before the railroad crossing, and with the exception of a case in which there is a stop sign and a case in which there is a red light, after safety of the situation has been confirmed, it is possible to pass through the railroad crossing without stopping.

In the regional information, there can be included information concerning facilities existing in the relevant regions. As the information concerning facilities existing in the relevant regions, there may be cited information in relation to the existence of barrier-free facilities, although the present invention is not limited to this feature.

In the regional information, there can be included information concerning transportation infrastructure of the relevant regions. As the information concerning transportation infrastructure of the relevant regions, there may be cited information in relation to the presence or absence of lanes dedicated to bicycles (bicycle lanes), although the present invention is not limited to this feature.

In the regional information, there can be included information concerning a percentage of elderly people in the relevant regions. By providing such information to the driver 12, the driver 12 can be alerted in relation to elderly pedestrians and the like.

In the regional information, there can be included information concerning a percentage of young people in the relevant regions. By providing such information to the driver 12, the driver 12 can be alerted in relation to young pedestrians and the like.

In the regional information, there can be included information concerning a percentage of small children in the relevant regions. By providing such information to the driver 12, the driver 12 can be alerted in relation to pedestrians who are small children and the like.

In the regional information, there can be included information concerning a percentage of people who have transferred into the relevant regions. Such transferees may have traffic accidents due to being unfamiliar with traffic conditions in the relevant regions. By providing such information to the driver 12, the driver 12 can be alerted to pay close attention to pedestrians.

In the regional information, there can be included information concerning disasters in the relevant regions. Information concerning disasters in the relevant regions may include, for example, flooding of rivers, although the present invention is not limited to this feature. By providing such information to the driver 12, it is possible to prevent the user's own vehicle 10 from becoming involved in trouble caused by a disaster.

The providing unit 30 can perform the following process, in the case it is determined by the determination unit 26 that the visiting experience of the driver 12 is less than the experience threshold value, or that the visiting interval of the driver 12 is greater than or equal to the interval threshold value. More specifically, in such cases, the providing unit 30 can provide information concerning the relevant regions, i.e., the regional information, to the driver 12 in accordance with the position of the user's own vehicle 10. The reason why such information concerning the relevant regions is provided in the case that the visiting experience of the driver 12 is less than the experience threshold value is because, in such a case, the driver 12 is anticipated to be lacking in information concerning the relevant regions. The reason why such information concerning the relevant regions is provided in the case that the visiting interval of the driver 12 is greater than or equal to the interval threshold value is because, in such a case, it is anticipated that the driver 12 may have forgotten the information concerning the relevant regions.

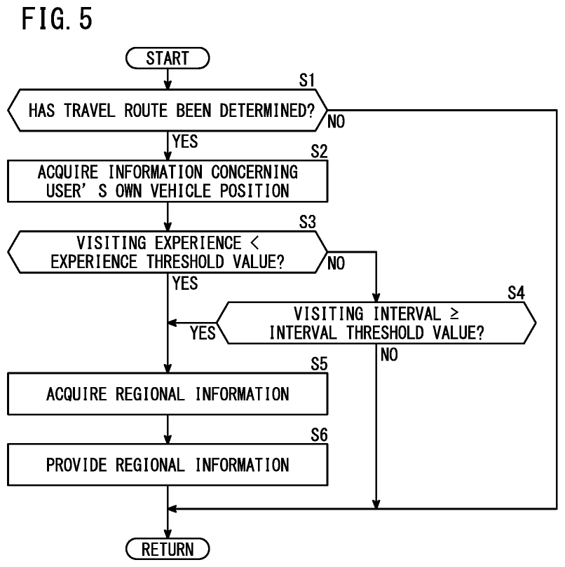

Next, operations of the information providing device according to the present embodiment will be described with reference to FIG. 5. FIG. 5 is a flowchart showing operations of the information providing device 14 according to the present embodiment.

In step S1, the control unit 19 determines whether or not a travel route has been determined. In the case that the travel route has been determined (YES in step S1), the process transitions to step S2. In the case that the travel route has not been determined (NO in step S1), the process shown in FIG. 5 is brought to an end.

In step S2, the position information acquisition unit 24 acquires information concerning the position of the user's own vehicle 10.

In step S3, the determination unit 26 determines whether or not the visiting experience of the driver 12 to the region located on the travel route is less than the experience threshold value (i.e., whether or not the visiting experience < the experience threshold value). It should be noted that, although it is possible to determine the visiting experience and the like with respect to visiting each of regions on the travel route from the current position of the user's own vehicle 10 to the destination, in this instance, in order to simplify the description, a case will be described as an example in which a visiting experience with respect to one region is determined. In the case that the visiting experience of the driver 12 to such a relevant region is greater than or equal to the experience threshold value (NO in step S3), the process transitions to step S4. In the case that the visiting experience of the driver 12 to the relevant region is less than the experience threshold value (YES in step S3), the process transitions to step S5.

In step S4, the determination unit 26 determines whether or not the visiting interval of the driver 12 to the relevant region is greater than or equal to an interval threshold value (i.e., whether or not the visiting interval the interval threshold value). In the case that the visiting interval of the driver 12 to the relevant region is greater than or equal to the interval threshold value (YES in step S4), the process transitions to step S5. In the case that the visiting interval of the driver 12 to the region is less than the interval threshold value (NO in step S4), the process shown in FIG. 5 is brought to an end.

In step S5, the regional information acquisition unit 28 acquires information concerning the relevant region, i.e., regional information, from the regional information database 38. Thereafter, the process transitions to step S6.

In step S6, the providing unit 30 provides the regional information acquired by the regional information acquisition unit 28 to the driver 12 via the HMI 41. For example, the providing unit 30 provides the driver 12 with regional information, and more specifically, information concerning a region where the distance of such a region from the current position of the user's own vehicle 10 is less than or equal to a predetermined distance. Upon doing so, the process shown in FIG. 5 is brought to an end.

In the foregoing manner, according to the present embodiment, the information concerning the region located on the travel route of the user's own vehicle 10 is provided based on the visiting experience and the like of the driver 12 with respect to the relevant region. Accordingly, the information providing device can be provided which is capable of providing information of the relevant region in accordance with the driving experience.

Although preferred embodiments of the present invention have been described above, the present invention is not limited to the above-described embodiments, and various modifications can be made thereto without departing from the essence and gist of the present invention.

For example, in the above embodiment, although an exemplary case has been described in which the travel route is determined by the travel route setting unit 22, the present invention is not necessarily limited to this feature. Determination of the travel route need not necessarily be preformed by the travel route setting unit 22. In this case, for example, the visiting experience and the like with respect to a region where the distance of such a region from the current position of the user's own vehicle 10 is less than or equal to a predetermined distance can be determined by the determination unit 26.

Summarizing the above-described embodiment and the modifications thereof, the characteristic features described below are realized.

The information providing device (14) is equipped with the position information acquisition unit (24) that acquires information concerning the position of the user's own vehicle (10), the determination unit (26) that determines whether or not a visiting experience of the driver (12) with respect to a region located on the travel route of the user's own vehicle is less than an experience threshold value, or alternatively, whether or not a visiting interval of the driver with respect to the region located on the travel route of the user's own vehicle is greater than or equal to an interval threshold value, the regional information acquisition unit (28) that acquires the regional information defined by information concerning the region located on the travel route of the user's own vehicle, and the providing unit (30) that provides the regional information acquired by the regional information acquisition unit in accordance with the position of the user's own vehicle, in the case it is determined by the determination unit that the visiting experience of the driver is less than the experience threshold value, or in the case it is determined by the determination unit that the visiting interval of the driver is greater than or equal to the interval threshold value. In accordance with such a configuration, information concerning the relevant region is provided to the driver based on the driver's visiting experience and the like in visiting the relevant region and the like. Therefore, the information providing device can be provided which is capable of providing information of the relevant region in accordance with the driving experience.

The regional information may include information concerning customs of the region.

The regional information may include information concerning traffic customs of the region.

The regional information may include information concerning facilities existing in the region.

The regional information may include information concerning transportation infrastructure of the region.

The regional information may include information concerning a percentage of elderly people in the region. In accordance with such a configuration, the driver can be alerted in relation to elderly pedestrians and the like.

The regional information may include information concerning a percentage of young people in the region. In accordance with such a configuration, the driver can be alerted in relation to young pedestrians and the like.

The regional information may include information concerning a percentage of small children in the region. In accordance with such a configuration, the driver can be alerted in relation to pedestrians who are small children and the like.

The regional information may include information concerning a percentage of people who have transferred into the region.

The regional information may include information concerning a disaster in the region.

The regional information acquisition unit may acquire the regional information from a social networking service.

The vehicle (10) is equipped with the information providing device as described above.

The method of providing information includes the step (step S2) of acquiring information concerning the position of the user's own vehicle, the determination step (step S3, step S4) of determining whether or not a visiting experience of the driver with respect to a region located on the travel route of the user's own vehicle is less than an experience threshold value, or alternatively, whether or not a visiting interval of the driver with respect to the region located on the travel route of the user's own vehicle is greater than or equal to an interval threshold value, the regional information acquisition step (step S5) of acquiring regional information defined by information concerning the region located on the travel route of the user's own vehicle, and the step (step S6) of providing the regional information acquired by the regional information acquisition step in accordance with the position of the user's own vehicle, in the case it is determined in the determination step that the visiting experience of the driver is less than the experience threshold value, or in the case it is determined in the determination step that the visiting interval of the driver is greater than or equal to the interval threshold value.

What is claimed is:

1. An information providing device comprising:
one or more processors that execute computer-executable instructions stored on a memory, wherein execution of the computer-executable instructions by the one or more processors cause the information providing device to:
acquire information concerning a position of a user's own vehicle;
determine whether or not a visiting experience of a driver with respect to a region located on a travel route of the user's own vehicle is less than an experience threshold value, or alternatively, whether or not a visiting interval of the driver with respect to the region located on the travel route of the user's own vehicle is greater than or equal to an interval threshold value;
acquire regional information defined by information concerning the region located on the travel route of the user's own vehicle; and
provide the acquired regional information in accordance with the position of the user's own vehicle, in a case it is determined that the visiting experience of the driver is less than the experience threshold value, or in a case it is determined that the visiting interval of the driver is greater than or equal to the interval threshold value.

2. The information providing device according to claim 1, wherein the regional information includes information concerning customs of the region.

3. The information providing device according to claim 1, wherein the regional information includes information concerning traffic customs of the region.

4. The information providing device according to claim 1, wherein the regional information includes information concerning facilities existing in the region.

5. The information providing device according to claim 1, wherein the regional information includes information concerning transportation infrastructure of the region.

6. The information providing device according to claim 1, wherein the regional information includes information concerning a percentage of elderly people in the region.

7. The information providing device according to claim 1, wherein the regional information includes information concerning a percentage of young people in the region.

8. The information providing device according to claim 1, wherein the regional information includes information concerning a percentage of small children in the region.

9. The information providing device according to claim 1, wherein the regional information includes information concerning a percentage of people who have transferred into the region.

10. The information providing device according to claim 1, wherein the regional information includes information concerning a disaster in the region.

11. The information providing device according to claim 1, wherein the one or more processors further cause the information providing device to acquire the regional information from a social networking service.

12. A vehicle comprising a information providing device,
wherein the information providing device comprises:
one or more processors that execute computer-executable instructions stored on a memory, wherein execution of the computer-executable instructions by the one or more processors cause the information providing device to:
acquire information concerning a position of a user's own vehicle;
determine whether or not a visiting experience of a driver with respect to a region located on a travel route of the user's own vehicle is less than an experience threshold value, or alternatively, whether or not a visiting interval of the driver with respect to the region located on the travel route of the user's own vehicle is greater than or equal to an interval threshold value;
acquire regional information defined by information concerning the region located on the travel route of the user's own vehicle; and
provide the acquired regional information in accordance with the position of the user's own vehicle, in a case it is determined that the visiting experience of the driver is less than the experience threshold value, or in a case it is determined that the visiting interval of the driver is greater than or equal to the interval threshold value.

13. A method of providing information, comprising:
acquiring information concerning a position of a user's own vehicle;
determining whether or not a visiting experience of a driver with respect to a region located on a travel route of the user's own vehicle is less than an experience threshold value, or alternatively, whether or not a visiting interval of the driver with respect to the region located on the travel route of the user's own vehicle is greater than or equal to an interval threshold value;
acquiring regional information defined by information concerning the region located on the travel route of the user's own vehicle; and
providing the regional information acquired in the acquiring of the regional information, in accordance with the position of the user's own vehicle, in a case it is determined, in the determining, that the visiting experience of the driver is less than the experience threshold value, or in a case it is determined, in the determining, that the visiting interval of the driver is greater than or equal to the interval threshold value.
